(19) United States
(12) Patent Application Publication
(10) Pub. No.: US 2004/0028800 A1
(43) Pub. Date: Feb. 12, 2004

(54) Fabricated snack food containing anti-sticking agent

(76) Inventors: Varadharajan Radhamani Basker, Plano, TX (US); Thomas George Crosby, Frisco, TX (US); Ximena Quintero Fuentes, Flower Mound, TX (US); William Douglas Henson, Duncanville, TX (US)

Correspondence Address: CARSTENS YEE & CAHOON, LLP, P O BOX 802334, DALLAS, TX, 75380

(21) Appl. No.: 10/217,850

(22) Filed: Aug. 12, 2002

(51) Int. Cl. A23L 1/216

(52) U.S. Cl. 426/637

(57) ABSTRACT

Snack food products, such as potato crisps or chips, are fabricated from dough that is processed into uncooked snack chips for cooking in a form fryer. Form fryers utilize conveyors that generally employ metal that contacts and retains the snack chips while being passed through an oil bath for frying. With the use of anti-sticking agent such as lecithin, the conveyors of the fryer do not need to be cooled prior to contacting the uncooked chips. The anti-sticking agent prevents the chip from adhering to the metal surfaces of a fryer conveyor that would otherwise cause a chip without anti-sticking agent to adhere thereto.

### BACKGROUND OF THE INVENTION

1. Technical Field

The present invention relates to the fabrication of a snack food containing an anti-sticking agent and process for making the same. More particularly, the invention relates to the fabrication of a fried snack food containing an anti-sticking agent and the process for making the same wherein the anti-sticking agent deters sticking from occurring when the food is cooked.

2. Description of Related Art

Snack foods formed from dough to approximate a potato or other chip are generally made from a sheeted dough that is cut into pieces for treatment. Treatment involves cooking, which is frying for example. The frying of individual pieces has numerous difficulties such as wrinkling, folding, clumping, and sticking to cooking surfaces. By using a form fryer, a number of these issues can be resolved. A form fryer is a fryer for producing snack chips having generally two conveyors, an upper and a lower conveyor. On each conveyor are molds or surfaces designed to interact with the opposing conveyors molds or surfaces. Thereby, snack chips conveyed between these conveyor surfaces can maintain their structure as desired.

One disadvantage of using a form fryer is that uncooked snack chip dough such as that for forming a potato crisp will adhere to excessively hot surfaces. A typical form fryer, for example, may be operated with an oil frying temperature between 340 to 370° F. As the conveyors pass through the oil, the conveyor adsorbs heat. If the temperature of the contact surface of the fryer conveyor is not significantly reduced, uncooked snack food dough is likely to adhere to the hot surface upon making contact. Therefore, prior art solutions have included reducing the temperature of the conveyor prior to contacting uncooked snack food dough to temperatures below 225° F. Cooling may be accomplished by mechanical methods such as blowers and by engineering large tracts of conveyor to pass through open-air sections to allow heat dissipation. Regardless of the cooling method used, large amounts of energy are lost due to this cooling. This heat lost through conveyor cooling is heat that must be added to the fryer's oil to maintain desired a cooking temperature. What is needed is to eliminate the need for cooling of the fryer conveyor surfaces while avoiding sticking issues.

Lecithin has been used in the prior art for its ability to aid in food processing. Particularly, lecithin is known to deter snack-piece-to-snack-piece sticking, cut slices of for example potato sticking to each other. Also, lecithin is known for its emulsifying ability, which is namely fat absorption and deterring spattering. Also, lecithin is known to deter sticking when sprayed onto a surface or if a product is washed with it.

The application of lecithin has been thought to be impractical, if not impossible, with frying applications. Ivers, U.S. Pat. No. 4,560,569, issued Dec. 24, 1985, discloses the addition of a lecithin-in-water suspension to dough-based fried snack foods to achieve beneficial dough transfer, treatment, and processing, which are known with the use of other emulsifiers such as mono and diglycerides. However, as disclosed by Ivers, the use of lecithin in fired foods is avoided because of the darkening of cooking oil. Ivers further notes that the addition of powdered lecithin to food products to be fried is not acceptable as significant oil darkening occurs rapidly. Ivers discloses no anti-sticking agent that can be added in a dry form in the fabrication of a snack chip, particularly a formed potato snack crisp or chip that will allow for the elimination or significant reduction for the need to cool fryer conveyors to prevent sticking.

Consequently, a need exists for a snack food formulation that when cooked will not stick to the cooking machinery surfaces without being cooled prior to contacting the uncooked food. A formulation such as this would allow cooking apparatus, for example a fryer, to avoid having to cool frying conveyor surfaces prior to contacting uncooked snack food such as potato chips. Thereby, a satisfactory and desired snack food can be produced while improving the processing efficiency and economics. This formulation is particularly needed where uncooked product is cooked while contacting one or more mold surfaces as in the production of uniform stackable snack chip products.

### SUMMARY OF THE INVENTION

Anti-sticking agent of the present invention allows for the prodution of snack food, particularly potato crisp or chip snacks, to be made with a form fryer such that cooling of the conveyor prior to contact uncooked dough is not needed. A snack product of the present invention has dry ingredients comprising potato flake, starches (natural and modified), sucrose, dextrose, emulsifier, and anti-sticking agent. This is a preferred formulation however other formulations are possible.

Products without the anti-sticking agent of the present invention made with of the same formulation and under the same conditions would stick to the metal surfaces of the fryer conveyor. This results in nearly the entire production of snack chips without anti-sticking agent produced being unacceptable. An unacceptable product, particularly of the formulations described herein, has longitudinal wrinkles due to the sticking and other deformities. This is undesirable particularly in an operation for producing a uniform stackable chip.

An anti-sticking agent of the present invention is lecithin. The lecithin is added in a substantially dry form to other dry ingredients of that form the dough. It is particularly advantageous to add the lecithin to any dry starches prior to blending with other dry ingredients. Following a hydration to form snack food dough, the mixture is sheeted and cut in desired uncooked chip pieces. These pieces are then delivered to a form fryer that does not need to reduce the temperature of any fryer conveyors used therein. With the anti-sticking agent, the chips do not adhere to metal surfaces of the fryer conveyors.

The above as well as additional features and advantages of the present invention will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a schematic side elevational view of an apparatus, including a fryer shown partially cut away, for fabricating snack foods made in accordance with the invention; and

FIG. 2 is a flow chart showing a process in accordance with the present invention for fabricating snack foods with anti-sticking agent.

### DETAILED DESCRIPTION

A snack food containing an anti-sticking agent of the present invention reduces, and more preferably eliminates, the need to cool cooking apparatus surfaces making initial contact with uncooked snack food. With large scale production of snack food, rotary conveyor type cooking apparatus are used to efficiently cook snack food. However, without the use of an anti-sticking agent as set forth herein, conventional apparatus need to allow the rotary conveyor surfaces to cool or be cooled prior to making contact with uncooked food. If not sufficiently cooled, food product not containing anti-sticking agent will likely stick to the hot cooking surface. This leads to unacceptable food products.

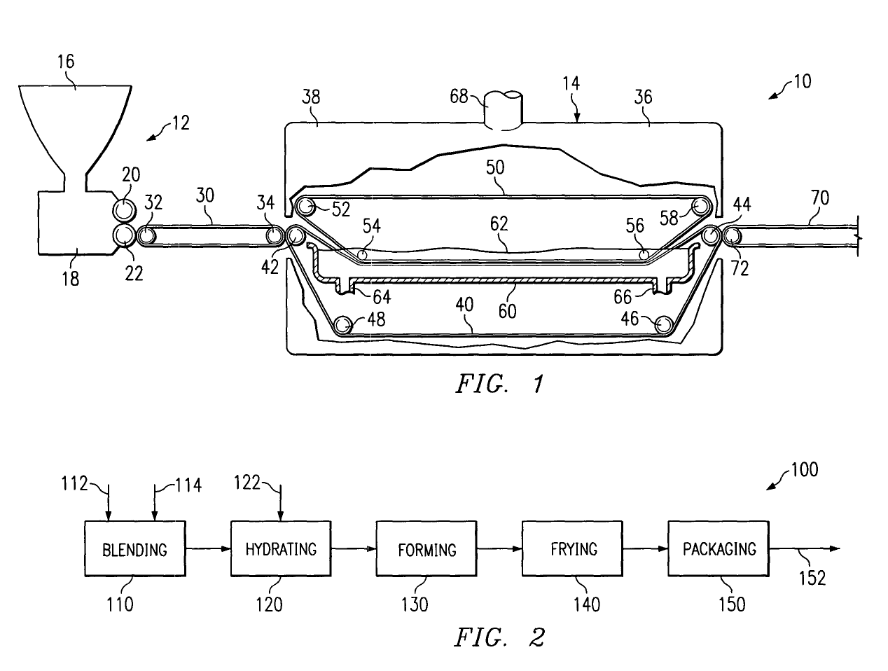

FIG. 1 shows an installation 10 for making a formed snack chip. Snack chips include products as potato chips, corn chips, tortilla chips, and the like, which as shown here, are typically cooked in a fryer. Although, anti-sticking agent described herein is effective in inhibiting sticking in other cooking processes such as baking. Installation 10 is shown with a pre-cooking segment 12 and a cooking segment 14 for making formed snack chips, which are, for example, uniformly shaped potato crisps or chips.

Installation 10 begins with dough formation. Dough made for this process comprises a substantially dry mixture of farinaceous material, sugar, and anti-sticking agent. A preferred farinaceous material is potato flake, which is essentially potato that has been flaked and dehydrated. Sugar is preferably sucrose but other sugars may be used or combined with sucrose. Additionally, dextrose is a preferred additive because of its ability to brown a substance upon cooking. Other substances that may be utilized include starches, native (unmodified) and modified, for their ability to improve the texture, consistency, and durability of food products and to improve the processing of dough into food products. With the preferred embodiment, the starches are potato starches. One or more emulsifiers, with mono and diglycerides preferred, may also be used for their ability to improve the processing of dough.

Emulsifiers improve the products made by deterring product clumping, defects such as surface deformities, and product-to-product sticking. Emulsifiers such as mono and diglycerides are effective at inhibiting product-to-product sticking because of, at least in part, the emulsification of surface starch on the products. However, mono and diglycerides are unknown to be effective as an anti-sticking agent. In preferred formulations of the invention where “emulsifier” is included, it should be deemed that the emulsifier and quantity that may be listed for it are separate from the anti-sticking agent.

An anti-sticking agent in accordance with the present invention is an additive added and mixed with the dry ingredients of a snack food, prior to being mixed with water to form dough, that is capable of inhibiting uncooked snack food from sticking to hot cooking surfaces. The preferred anti-sticking agent is lecithin. Lecithin is generally a class of compounds that are mixed esters of glycerol and choline with fatty acids and phosphoric acid. Prior to the present invention, lecithin has only been thought of for its emulsifying ability. Further, lecithin has been thought to be undesirable in frying applications because of its buildup of free fatty acids and darkening of the cooking oil. Prior applications of lecithin have not been as an anti-sticking agent. As such, a snack food product has not been produced with lecithin as an anti-sticking agent. Additionally with the use of lecithin as an anti-sticking agent, starch based snack foods processed with it will also benefit from its emulsifying and lubricating properties.

Returning to FIG. 1, a dry mixture in accordance with the invention is hydrated and mixed to form dough in dough formation 16. The dough is processed into a sheet with sheeter 18. Sheeting rollers 20 and 22 form flat uncooked pieces of chip dough that are delivered onto uncooked chip conveyor 30 at pickup roller 32. Conveyor 30 is supported by rollers 32 and 34 and conveys the uncooked chips towards cooking segment 14, which contains a form fryer 36 housed within a fryer housing 38. While fryer 36 is shown as a twin conveyor fryer, alternative form fryers may be employed such as a single conveyor form fryer.

The uncooked snack chips are delivered from conveyor 30 at roller 34 to a bottom fryer conveyor 40 at pickup roller 42. Conveyor 40 is comprised of metal in a chain link manner (not shown). It should be understood that this embodiment has a series of rows of molds (not shown), which are also comprised of metal, extending longitudinally along the surface of conveyor 40 to form uniformly shaped chips. Conveyor 40 is supported by rollers 42, 44, 46, and 48 so as to form a continuous loop within a bottom portion of fryer 36. Disposed above and in a complimentary to bottom fryer conveyor 40 is top fryer conveyor 50. Top fryer conveyor 50 is of similar construction to conveyor 40 with mold portions (not shown) disposed on conveyor 50 designed to mate with the molds disposed on conveyor 40. Conveyor 50 is supported by rollers 52, 54, 56, and 58 so as to form a continuous loop within a top portion of fryer 36. The snack chips traveling on the mold portions of conveyor 40 are met with the mold portions of conveyor 50 shortly after entering housing 38. The uncooked chips become sandwiched between the two conveyors 40 and 50 for immersion into oil bath 60.

Here, the anti-sticking agent in the dough is particularly advantageous. Fryers, such as fryer 36, are designed to operate at high temperatures to ensure that uncooked snack food gets cooked. Fryer 36 is a form fryer, i.e., a fryer designed to hold and contact the snack chips as they get cooked. Until the discovery of the anti-sticking agent of this invention, the cooking surfaces of the fryer, which are the conveyors 40 and 50 and the mold portions thereon, would have to have their temperatures reduced prior to contacting uncooked pieces of snack food. Otherwise, an uncooked snack food would likely become at least partially adhered to the metallic cooking surface(s). This would lead to unacceptable chip products being produced as the chips would develop longitudinal wrinkles and loose their uniform shape. Additionally, product that might separate from the snack chip and stay adhered to the surface of a mold will become an unacceptable piece of matter and likely contaminate other snack chips being produced.

As conveyors 40 and 50 now in contact with snack chips therebetween, enter into the oil of oil bath 60 at oil line 62. Rollers 54 and 56 provide support and guidance of conveyors 40 and 50 as they travel through oil bath 60. The oil used for the frying is oil such as cottonseed, vegetable, other common cooking oil, or mixtures thereof. The oil in oil bath 60 is maintained and circulated with oil ports 64 and 66. Heating elements (not shown) maintained the desired cooking temperature of oil bath 60. As snack chips are cooked, moisture is released therefrom and can be withdrawn via duct 68. Also, duct 68 or other ducts not shown can be used to provide an inert gas or steam to maintain a desired environment above oil bath 60 to inhibit oxidation of snack chips being cooked and oil.

Upon exiting oil bath 60 at about roller 56, the snack chip is nearing the exit of fryer 36. At about roller 58, upper frying conveyor 50 separates with the snack chip not substantially, if at all, adhering to the metal of frying conveyor 50. The snack chips are then passed from the lower frying conveyor 40 at about roller 42 to a conveyor 70 at about roller 72. Conveyor 70 is positioned at the exit of fryer 36 to transfer the now cooked snack chips to finishing operations, which include generally seasoning and packaging.

Preferred formulations of snack chips include the ingredients within about the weight percentages listed in Table 1. Snack chips made within about the preferred ranges listed in Table 1 are similar in taste, texture, and appearance as to the same snack chips made without lecithin. In consideration of the ingredients listed in Table 1, the following should be noted: the starches are potato starches; the emulsifier is comprised of mono and diglycerides; and the lecithin is comprised of a mixture of phosphatidyl choline (chemical lecithin), phosphatidyl ethanolamine, phosaphatidyl inositol, phosphatidyl serine, phosphatidic acid. Other lecithin may be substituted with little affect if any such as lyso or hydroxylated versions.

TABLE 1

| Ingredients | Minimum % | Preferred % | Maximum % |
|---|---|---|---|
| Water | 30 | 34.4-35.5 | 36 |
| Potato Flakes | 55 | 57.0-58.0 | 68 |
| Native Starch | 0 | 1.0-2.0 | 3 |
| Modified Starch | 0 | 1.0-2.0 | 3 |
| Emulsifier | 0 | 0.6-0.9 | 5 |
| Lecithin | 0.05 | 0.1-0.15 | 0.40 |
| Sucrose | 1 | 1.5-2.0 | 4 |
| Dextrose | 0 | 0.2-0.4 | 1 |

Referring now to FIG. 2, a process 100 is shown for fabricating a snack chip in accordance with the invention. Blending 110 comprises mixing the dry ingredients listed above with anti-sticking agent prior to being formed into a dough. Process 100 shows a preferred mixing where a blended dry component 112 comprising potato flake, sucrose, dextrose, and emulsifier are added to blending 110 separate from dry component 114. Dry component 114 is a blended dry mixture of natural and modified starches with anti-sticking agent. By preblending anti-sticking agent with the starches, a benefit is achieved in allowing improved processing of the dry mixture. The dry mixture from blending 110 is processed into dough in hydrating 120 with water 122. The dough is sheeted and formed into uncooked chips in forming 130. These uncooked chips are then cooked in frying 140, which as explained above, utilizing a form fryer. After being cooked, the cooked chips are optionally seasoned and then packaged in packaging 150. From packaging 150, finished packaged snack chips containing lecithin are formed. Further, the finished snack chips, with their uniform shaped, can be packaged as stacked chips in a canister.

With the use of an anti-sticking agent, particularly lecithin, fryers using handling pieces that contact the uncooked dough of snack food do not have to be cooled. With prior art form fryers, the conveyors, belts, or rollers needed to be cooled prior to contacting the uncooked dough to prevent sticking. This would require the design to incorporate a way for these devices to dissipate heat from the contact surface while not contacting snack food. Regardless of whether the dissipation of heat used mechanical devices or not to provide cooling, the loss of heat means that the heat within an oil bath must compensate for this constant drain. This leads to supplying more heat than is needed if the product is made with an anti-sticking agent in accordance with the invention. If mechanical devices are used to cool, then even more energy must be supplied to the overall system. Hence, snack food products made with an anti-sticking agent of the invention can be made more efficiently and economically.

While the invention has been particularly shown and described with reference to a preferred embodiment, it will be understood by those skilled in the art that various changes in form and detail may be made therein without departing from the spirit and scope of the invention.

What is claimed is:

1. A snack chip fabricated with anti-sticking agent, comprising:
a substantially dry mixture of potato, sugar, and anti-sticking agent; and
water wherein said dry mixture and said water are mixed and formed into uncooked snack chips that that are moved through a fryer with a conveyor, said anti-sticking agent prevents the snack chip from adhering to the surface of said fryer conveyor.

2. The snack chip of claim 1 wherein said dry mixture further comprises starch and emulsifier.

3. The snack chip of claim 2 wherein said snack chip is formed from a snack chip dough comprising by weight: water selected from between about 30 to about 36%, potato flake selected between about 55 to about 68%, a native starch selected between 0 to about 3%, a modified starch selected between 0 to about 3%, emulsifier selected between 0 to about 5%, sucrose selected from about 1 to about 4%, dextrose selected from 0 to about 1%, and lecithin selected from about 0.05 to about 0.40%.

4. The snack chip of claim 3 wherein said snack chip is formed from a snack chip dough comprising by weight: water selected from between about 34.4 to about 35.5%, potato flake selected between about 57.0 to about 58.0%, a native starch selected between about 1.0 to about 2.0%, a modified starch selected between about 1.0 to about 2.0%, emulsifier selected between about 0.6 to about 0.9%, sucrose selected from about 1.5 to about 2.0%, dextrose selected from about 0.2 to about 0.4%, and lecithin selected from about 0.1 to about 0.15%.

5. The snack chip of claim 1 wherein the snack chip produced with anti-sticking agent is cooked with in a fryer.

6. The snack chip of claim 1 wherein the snack chips produced are substantially the same as snack chips produced without anti-sticking agent that are made using a form fryer having one or more fryer conveyors that are cooled prior to contacting uncooked snack chip dough without anti-sticking agent.

7. The snack chip of claim 1 wherein the snack chips produced are uniformly shaped and stackable for packaging.

8. A process for fabricating snack chips having anti-sticking agent, comprising:
providing a substantially dry mixture of potato, sugar, and anti-sticking agent;
hydrating said dry mixture into a snack chip dough;
forming uncooked snack chips from said snack chip dough; and
cooking said uncooked snack chips in a fryer having at least one fryer conveyor wherein said anti-sticking agent prevents the snack chips from adhering to a surface of said fryer conveyor.

9. The process for fabricating snack chips of claim 8, wherein said providing the substantially dry mixture further comprises adding, by weight: potato flake selected between about 55 to about 68%, a native starch selected between 0 to about 3%, a modified starch selected between 0 to about 3%, emulsifier selected between 0 to about 5%, sucrose selected from about 1 to about 4%, dextrose selected from 0 to about 1%, and lecithin selected from about 0.05 to about 0.40%.

10. The process for fabricating snack chips of claim 9, wherein said providing the substantially dry mixture further comprises adding, by weight: potato flake selected between about 57.0 to about 58.0%, a native starch selected between about 1.0 to about 2.0%, a modified starch selected between about 1.0 to about 2.0%, emulsifier selected between about 0.6 to about 0.9%, sucrose selected from about 1.5 to about 2.0%, dextrose selected from about 0.2 to about 0.4%, and lecithin selected from about 0.1 to about 0.15%.

11. The process for fabricating snack chips of claim 10 wherein said hydrating forms a dough of about 30 to about 36% by weight of water.

12. The process for fabricating snack chips of claim 11 wherein said hydrating forms a dough of about 34.4 to about 35.5% by weight of water.

13. The process for fabricating snack chips of claim 8 wherein said fryer conveyor has no means for cooling to deter snack chips from adhering to any surfaces of said fryer conveyor.

14. The process for fabricating snack chips of claim 8 wherein said fryer conveyor has a temperature greater than about 225° F. upon contacting said uncooked snack chips.

15. The process for fabricating snack chips of claim 8 wherein said fryer conveyor has a temperature greater than about 330° F. upon contacting said uncooked snack chips.

16. A process for fabricating snack chips using a fryer with at least one conveyor, comprising:
providing a substantially dry mixture of potato, anti-sticking agent, and sugar;
hydrating said dry mixture into a snack chip dough;
forming uncooked snack chips from said snack chip dough; and
providing said fryer with said at least one conveyor wherein the conveyor is not cooled prior to contacting said uncooked snack chips; and
conveying the uncooked snack chips through said fryer with said conveyor.

17. The process for fabricating snack chips of claim 16 wherein said providing the substantially dry mixture further comprises adding, by weight: potato flake selected between about 55 to about 68%, a native starch selected between 0 to about 3%, a modified starch selected between 0 to about 3%, emulsifier selected between 0 to about 5%, sucrose selected from about 1 to about 4%, dextrose selected from 0 to about 1%, and lecithin selected from about 0.05 to about 0.40%.

18. The process for fabricating snack chips of claim 17, wherein said providing the substantially dry mixture further comprises adding, by weight: potato flake selected between about 57.0 to about 58.0%, a native starch selected between about 1.0 to about 2.0%, a modified starch selected between about 1.0 to about 2.0%, emulsifier selected between about 0.6 to about 0.9%, sucrose selected from about 1.5 to about 2.0%, dextrose selected from about 0.2 to about 0.4%, and lecithin selected from about 0.1 to about 0.15%.

19. The process for fabricating snack chips of claim 16 wherein said fryer conveyor has a temperature greater than about 225° F. upon contacting said uncooked snack chips.

20. The process for fabricating snack chips of claim 16 wherein said fryer conveyor has a temperature greater than about 330° F. upon contacting said uncooked snack chips.
